(19) United States
(12) Patent Application Publication
(10) Pub. No.: US 2026/0367662 A1
(43) Pub. Date: Nov. 19, 2026

(54) BALANCED-INTERFERENCE PHOTONIC PROCESSOR WITH EIGHT-TICK RECOGNITION LEDGER ENFORCEMENT

(71) Applicant: Jonathan Washburn, Austin, TX (US)

(72) Inventor: Jonathan Washburn, Austin, TX (US)

(21) Appl. No.: 19/676,254

(22) Filed: May 13, 2026

Related U.S. Application Data
(60) Provisional application No. 63/805,946, filed on May 14, 2025.

(51) Int. Cl. G06E 1/00

(52) U.S. Cl. CPC G06E 1/00

(57) ABSTRACT

An integrated photonic processor cell receives an eight-channel optical word and interferometrically isolates a DC or summed balance witness component from non-balance optical content. The witness component is routed to a balance output structure, preferably a dedicated balance port, while non-balance optical content is routed to one or more compute outputs. Residual optical output at the balance output structure is detected and compared with a threshold condition to generate an electrical imbalance signal for computation control. In disclosed implementations, the balance output structure carries a scaled sum or DC coefficient of the eight channel amplitudes and is null if and only if the optical word is ledger-neutral at a disclosed model level. Preferred embodiments include silicon-nitride waveguides, an 8-point interferometric transform, balanced photodetection, phase trimming, calibration under a known neutral input pattern, and control responses including invalidation, rollback, re-execution, exception handling, or recalibration.

### CROSS-REFERENCE TO RELATED APPLICATIONS

This application claims the benefit of U.S. Provisional Patent Application No. 63/805,946, filed May 14, 2025, the entire disclosure of which is incorporated herein by reference.

### BACKGROUND OF THE INVENTION

This disclosure relates to integrated photonic processors and, more particularly, to an eight-input photonic processor architecture that physically separates a DC or summed balance witness component of an optical word from non-DC compute content, detects imbalance in the optical domain at a dedicated balance port, and uses that imbalance detection to control computation. Silicon photonics, silicon-nitride photonics, Mach-Zehnder interferometers, multimode-interference couplers, and related integrated optical structures have been used to perform high-throughput and low-latency optical processing, including matrix multiplication, convolution, Fourier-type processing, modulation, routing, and signal transformation. Such devices can exploit optical interference, phase encoding, wavelength routing, and integrated waveguide structures to process information at speeds and bandwidths that are difficult to obtain using purely electronic circuitry.

Existing photonic accelerators, however, generally do not natively enforce algebraic balance at the level of an optical instruction word, operand word, or eight-channel optical word. In many photonic processing systems, optical amplitudes or phases are processed to obtain a computational result, but the optical hardware does not itself provide a dedicated balance witness that directly indicates whether an input word or intermediate word satisfies a neutrality condition. As a result, errors, drift, operand corruption, phase misalignment, or channel imbalance may accumulate or propagate before being detected by downstream circuitry.

Some fault-tolerant or error-aware photonic systems rely on electronic checking after optical processing. For example, an optical result may be detected, digitized, and then processed by electronic comparison, checksum, parity, or error-correction logic. Such downstream electronic checking can add latency, consume additional power, and require extra signal-conversion hardware. The checking operation is also separated from the optical-domain physical event that produced the error, which can delay corrective action.

Prior integrated-photonic layouts also do not provide a self-referencing null output whose optical intensity directly encodes algebraic neutrality of an optical word. Conventional interferometric outputs may represent transformed data, bar and cross states, constructive-interference outputs, destructive-interference outputs, or routing states, but they are not configured as a dedicated DC or summed witness channel whose null condition corresponds to neutrality of the input optical word.

Prior systems further do not physically separate an eight-channel optical input space into a neutral compute subspace and a DC balance-witness subspace in the manner disclosed herein. In the disclosed architecture, the non-DC components define a neutral compute subspace, while a dedicated balance port carries the DC or summed balance witness component. This physical separation allows the balance port to serve as a passive optical-domain witness of neutrality while the non-DC content is routed for computation.

There remains a need for an integrated photonic processor cell that receives an eight-channel optical word, interferometrically isolates a DC or summed balance witness component, routes that component to a dedicated balance port, detects residual balance-port output, and generates an electrical imbalance signal suitable for computation control. There is also a need for such a processor cell in which the balance-port null condition is tied to a formal neutrality relation, so that neutral optical words do not trigger the imbalance signal and flagged optical words are not neutral at the disclosed model level.

### SUMMARY OF THE INVENTION

Disclosed herein are integrated photonic processor cells, systems, and methods for optical-domain balance enforcement. In one aspect, an eight-channel optical word is received by an integrated photonic processor cell and is interferometrically processed so that a DC or summed balance witness component of the optical word is separated from non-balance optical content. The balance witness component is routed to a balance output structure, preferably a dedicated balance port, and residual optical output at the balance output structure is detected to generate an electrical imbalance signal for computation control.

In disclosed implementations, the optical word includes eight optical channels, each corresponding to a respective complex amplitude, phase-encoded amplitude, or optical signal component. The interferometric processing may implement an 8-point transform in which a DC coefficient corresponds to a scaled sum of the input amplitudes. The balance port thereby physically realizes the DC witness channel of the optical word. At the disclosed model level—that is, in the idealized eight-channel complex-amplitude model defined herein in which optical loss and detector noise are not applied-the balance-port amplitude is zero if and only if the optical word is ledger-neutral.

The disclosed architecture separates the eight-channel optical input space into a one-dimensional DC balance subspace and a seven-dimensional neutral compute subspace. The DC balance subspace is routed to the balance port, while the non-DC components are routed to one or more compute outputs. Valid computation occurs in the disclosed neutral compute subspace, while the balance port provides a passive optical-domain witness of neutrality.

Residual balance-port power above a threshold condition is converted into an electrical imbalance signal. In disclosed embodiments, the imbalance signal may be used to modify, gate, suppress, qualify, invalidate, stall, rewind, roll back, re-execute, restore a checkpoint state, or otherwise control computation. Rollback and re-execution are preferred control consequences, but the broader architecture does not require rollback in every embodiment.

In preferred implementations, the processor cell includes eight silicon-nitride waveguides on a silicon-on-insulator substrate, phase-shifter elements associated with the waveguides, an interferometric coupler network, a dedicated balance port, one or more compute outputs, and at least one photodetector optically coupled to the balance port. In some preferred embodiments, the interferometric coupler network includes a three-stage cascade of 2×2 multimode-interference couplers configured to implement the 8-point transform. In some preferred embodiments, dual balanced photodiodes detect residual balance-port power and generate an imbalance flag.

Preferred embodiments may further include phase-trimming heaters, calibration circuitry, and a successive-approximation calibration controller configured to reduce or minimize balance-port output under a known neutral input pattern. Preferred disclosed implementation targets include sub-5 ns imbalance detection, at least 30 dB balance-port extinction under calibrated neutral conditions, a 40 MS/s symbol rate, approximately 96 mW total power per cell, approximately 1.44 mm2 die area per cell, and multi-cell array throughput of approximately 2.56 GS/s for a 64-cell array. These values are preferred disclosed implementation targets and are not required in every embodiment.

The disclosure also includes mathematical and formal-verification support for the balance-witness architecture. In the disclosed model, balance power is nonnegative, balance power is zero if and only if the optical word is ledger-neutral, the DFT balance-port amplitude is zero if and only if the optical word is ledger-neutral, neutral words never trigger the imbalance flag, and flagged words are never neutral. The balance-port null condition is also disclosed as a hardware realization of the eight-tick phase-cancellation identity in which the eight eighth-root-of-unity phases sum to zero.

The disclosed processor cell may be used as a balanced arithmetic accelerator, a photonic fault-tolerant processor element, a self-checking photonic neural-network engine, a quantum syndrome checker, an optical transaction verifier, or another optical-domain computation-control module. These downstream applications are examples of use environments for the core eight-input DC-witness architecture.

### BRIEF DESCRIPTION OF THE DRAWINGS

FIG. 1 schematically illustrates an integrated photonic processor cell including eight optical inputs, an interferometric network, one or more compute outputs, a dedicated balance port, a detector coupled to the balance port, and a control path carrying an imbalance signal.

FIG. 2 schematically illustrates an optical word model in which eight optical channel amplitudes define a summed balance witness quantity, with neutral and non-neutral optical words producing different balance-port conditions.

FIG. 3 schematically illustrates decomposition of the eight-channel optical input space into a seven-dimensional neutral compute subspace and a one-dimensional DC balance subspace, with non-DC components routed to compute output structure and the DC witness component routed to the balance port.

FIG. 4 schematically illustrates a preferred three-stage multimode-interference coupler cascade configured to implement an 8-point interferometric transform for separating the DC witness component from non-DC optical content.

FIG. 5 schematically illustrates a balance-port detection path including optical detection of residual balance-port output, threshold comparison, imbalance flag generation, and detector soundness logic.

FIG. 6 schematically illustrates a rollback timing and computation-control workflow in which an imbalance signal causes one or more control responses including invalidation, stall, rewind, rollback, re-execution, checkpoint restoration, or exception handling.

FIG. 7 schematically illustrates representative operand encoding options for the eight optical inputs, including binary phase-shift-keyed encoding, multilevel phase-shift-keyed or quadrature-amplitude encoding, and root-of-unity carrier encoding.

FIG. 8 schematically illustrates thermal calibration and phase trimming, including heater control, detector feedback, calibration triggering, trim-state storage, and periodic refresh.

FIG. 9 schematically illustrates an electrical interface and die layout for a preferred integrated photonic processor cell, including phase-data inputs, calibration input, imbalance output, compute output, power rails, pads, and photonic routing regions.

FIG. 10 schematically illustrates a fabrication cross-section and process flow for a preferred implementation including waveguide formation, cladding deposition, heater fabrication, photodiode integration, metallization, and packaging.

FIG. 11 schematically illustrates a multi-cell array and processor integration embodiment in which a plurality of photonic processor cells provide optical-domain imbalance checking for a processor or accelerator.

FIG. 12 schematically illustrates downstream application embodiments, including a balanced arithmetic accelerator, a photonic fault-tolerant processor, a self-checking photonic neural-network engine, a quantum syndrome checker, and an optical transaction verifier.

FIG. 13 schematically illustrates optional alternative photonic implementations and prophetic extended-channel configurations, including alternative photonic materials, alternative detector arrangements, alternative phase-shifter structures, and extended-channel transform configurations.

### DETAILED DESCRIPTION OF THE INVENTION

The following detailed description describes embodiments of an eight-channel integrated photonic processor with balance-witness output detection. The disclosure is directed to an integrated photonic processor architecture in which an eight-channel optical word is processed in the optical domain so that a DC or summed balance witness component is physically separated from non-balance optical content, routed to a balance output structure, detected, and used to generate an electrical imbalance signal for computation control. The disclosed invention is not photonic computing in general and is not Recognition Science in general. The disclosed invention is the eight-input integrated photonic balance-enforcement architecture in which a balance output structure, preferably a dedicated balance port, physically realizes a DC or summed witness channel of an optical word, and in which residual balance-port output provides an optical-domain imbalance witness.

Definitions and interpretive tiers are provided to clarify the scope of the disclosed architecture. The term “disclosed model level” means the idealized eight-channel complex-amplitude model in which the optical word 106 is represented as =(w0, w1, w2, w3, w4, w5, w6, w7), optical loss and detector noise are not applied, and the balance relation is evaluated by the channel sum, the DC transform coefficient, or an equivalent balance-witness quantity. Statements herein qualified by the phrase “at the disclosed model level” or “at a disclosed model level” refer to evaluation under this idealized model and provide an objective benchmark for evaluating disclosed and claimed relations in the absence of physical-implementation effects such as optical loss, detector noise, calibration error, and threshold quantization. Practical physical embodiments may approximate that model through calibration, extinction, thresholding, and detector-noise margins.

The term “optical word” refers to an ordered eight-element set of optical channel values carried by the eight optical inputs 102. The term “balance amplitude” means the sum of the eight channel amplitudes, namely balanceAmplitude(w)=sum_{k=0}\hat{ }7 wk. The term “balance power” means the squared modulus of the balance amplitude, namely balancePower(w)=|balanceAmplitude(w)|\hat{ }2. The term “ledger-neutral” or “neutral” means that balanceAmplitude(w)=0 at the disclosed model level. The term “DC or summed balance witness component” means the optical component, coefficient, path content, or signal portion corresponding to the channel sum, scaled channel sum, DC mode, or k=0 transform component of the optical word 106.

The term “balance output structure” means an optical output structure that carries the DC or summed balance witness component toward optical detection. A balance output structure may be implemented as a dedicated balance port, balance output path, output waveguide, output region, monitoring tap, optical branch, detector-coupled output, off-chip-coupled output, or equivalent optical structure that carries the balance witness component. The balance output structure is distinct from an arbitrary compute output because it carries the witness component used to determine whether the optical word 106 satisfies the disclosed neutrality condition. The term “balance port” means a dedicated or identifiable optical output that carries the DC or summed balance witness component of the optical word 106. The term “balance witness component” refers to the DC or summed balance witness component carried by the balance output structure 114 or dedicated balance port 116.

The term “neutral subspace” means the disclosed span of the non-DC modes of the eight-channel transform space. The term “balance subspace” means the disclosed DC witness mode. The term “imbalance signal” means an electrical signal generated in response to residual balance output satisfying a threshold condition.

The word “null” is used in a tiered manner. A formal null output means exact zero balance-port amplitude or exact zero balance-port output at the disclosed mathematical model level. An operational null output means substantially null, suppressed, or extinction-limited balance output in a calibrated physical embodiment operating within disclosed tolerance, symmetry, detector-noise, and extinction conditions. A threshold-qualified non-triggering output means balance output that does not satisfy the implemented imbalance-trigger condition in practical detector operation. Thus, a formal null may correspond to exact zero in the model, while a practical physical null may correspond to an output that is sufficiently suppressed to be accepted by the threshold logic 120.

Neutrality is also used in a tiered manner. Formal neutrality means balanceAmplitude(w)=0 and, in the disclosed transform model, dftBalancePortAmplitude(w)=0. Operational neutrality means a calibrated physical state in which balance-port optical output remains within accepted tolerance and does not exceed the disclosed imbalance threshold. Accepted neutrality means a practical decision state in which the processor cell 100 accepts the optical word 106 as non-flagged under the implemented threshold logic 120. These tiers support exact mathematical disclosure, calibrated physical implementation, and practical threshold-based operation without confusing one level with another.

Computation control is likewise disclosed at multiple levels. At a broad level, computation control includes generation of the electrical imbalance signal 122. At an intermediate level, computation control includes using the imbalance signal 122 to modify, gate, suppress, qualify, delay, mark, reject, or condition a computation or computational result. At a narrower level, computation control includes invalidation, stall, rewind, rollback, re-execution, checkpoint restoration, selective replay, exception handling, interrupt generation, recalibration request, output suppression, or comparable processor-control responses. Rollback is an important preferred control consequence, but rollback is not required in every embodiment.

The disclosed balance relation is grounded in an eight-channel structure. In one disclosed mathematical foundation, the eight-tick phase identity is sum_{k=0}\hat{ }7 exp(2 pii*k/8)=0. This identity states that the eight eighth-root-of-unity phases cancel in the aggregate. The broader mathematical support includes the Recognition Composition Law J(xy) +J(x/y)=2J(x)J(y)+2J(x)+2J(y), the corresponding cost function J(x)=½*(x+1/x)−1, the BALANCE operator concept as a projection I-(⅛)*11\hat{ }T onto a sum-zero subspace, the relation phi\hat{ }2=phi+1, and the coherence quantity E_coh=phi\hat{ }−5, where the coherence exponent is 5=2\hat{ }D-D for D=3. These mathematical elements are included as support for the disclosed balance relation and not as an attempt to claim Recognition Science generally. The disclosed photonic processor cell 100 implements an optical hardware analogue of the eight-tick cancellation by separating the DC or summed component of an eight-channel optical word 106 from its non-DC content. The null condition at the balance port 116 is therefore the hardware realization of the eight-tick phase-cancellation identity through the disclosed eight-input DC-witness architecture. Recognition Science material is included only as support for the optical architecture, the balance relation, the subspace decomposition, and the formal verification anchors. The invention is not the Recognition Science framework as a whole.

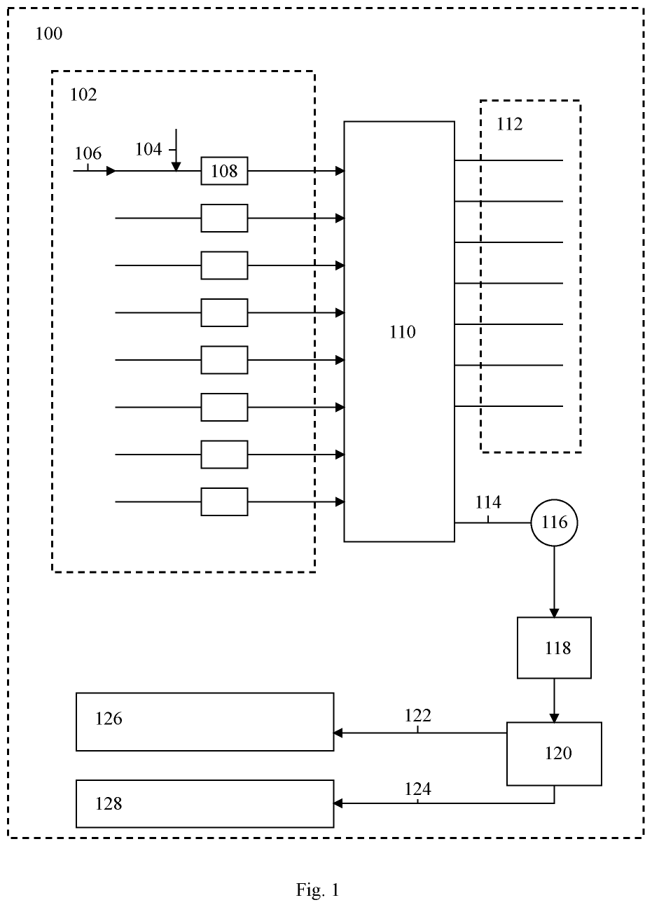

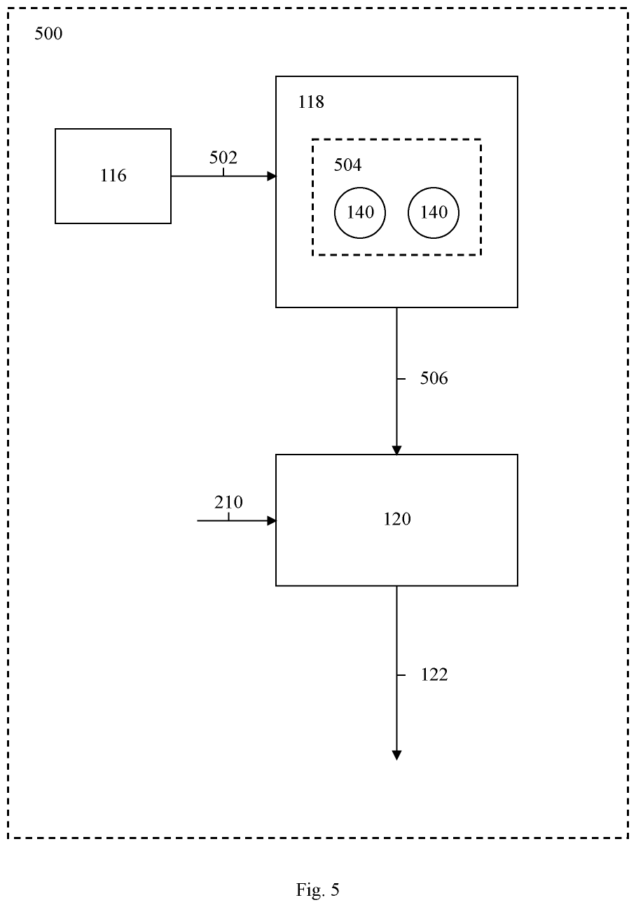

FIG. 1 illustrates a preferred integrated photonic processor cell 100. The processor cell 100 includes eight optical inputs 102 carried by waveguides 104 that together carry an optical word 106. Phase-shifter elements 108 are associated with respective ones of the waveguides 104. The optical word 106 enters an interferometric network 110 that isolates a DC or summed balance witness component of the optical word 106 from non-balance optical content. The non-balance optical content is routed by the interferometric network 110 to one or more compute outputs 112. The DC or summed balance witness component is routed to a balance output structure 114, which in a preferred implementation comprises a dedicated balance port 116. A detector 118 is optically coupled to the balance output structure 114 and supplies a detector output to threshold logic 120. The threshold logic 120 generates an electrical imbalance signal 122 that is conveyed along a control path 124 to a processor 126 and a rollback controller 128 for computation control. A calibration controller 130 cooperates with heater elements 132 and trim memory 134 to maintain calibrated operation of the processor cell 100. The processor cell 100 is fabricated on a substrate 136 with a cladding layer 138 and integrated photodiodes 140, and is electrically coupled to off-chip circuitry through electrical pads 142, as further described in connection with FIGS. 5, 8, 9, and 10.

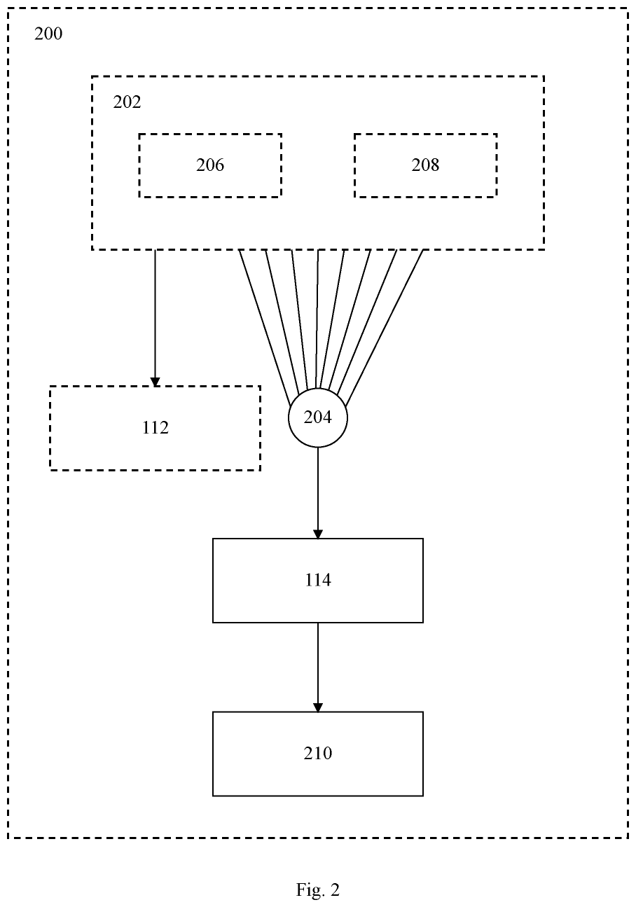

FIG. 2 illustrates an optical word model 200. The optical word model 200 includes eight channel amplitudes 202 corresponding to the eight optical inputs 102. A balance summing relation 204 forms a summed witness quantity from the eight channel amplitudes 202. A neutral optical word 206 has balanceAmplitude(w)=0. A non-neutral optical word 208 has balanceAmplitude(w)!=0. A threshold level 210 is used in practical detector operation to determine whether residual balance output should generate the imbalance signal 122. The balance output structure 114 carries the optical manifestation of the balance summing relation 204, while the compute outputs 112 carry optical content not assigned to the balance witness.

In the formal model, the neutral optical word 206 produces zero balance power. In a calibrated physical embodiment, the neutral optical word 206 produces a substantially null or suppressed output at the balance port 116, and that output remains below the threshold level 210. In the formal model, the non-neutral optical word 208 produces nonzero balance amplitude and therefore positive balance power. In a practical embodiment, the non-neutral optical word 208 produces residual optical output at the balance port 116, and the detector 118 and threshold logic 120 determine whether the residual optical output is sufficient to assert the imbalance signal 122.

Because balancePower(w) is defined as |balanceAmplitude(w)|\hat{ }2, balancePower(w) is nonnegative. At the disclosed model level, balancePower(w)=0 if and only if the optical word 106 is ledger-neutral. This biconditional relation is a load-bearing support statement for the architecture. It is the reason that the balance output structure 114 can serve as an optical-domain witness of neutrality. A neutral word causes no formal balance power, and a non-neutral word causes nonzero formal balance power. In a calibrated physical embodiment, detector noise, optical loss, extinction, threshold setting, and calibration tolerance are used to translate the formal relation into practical operation.

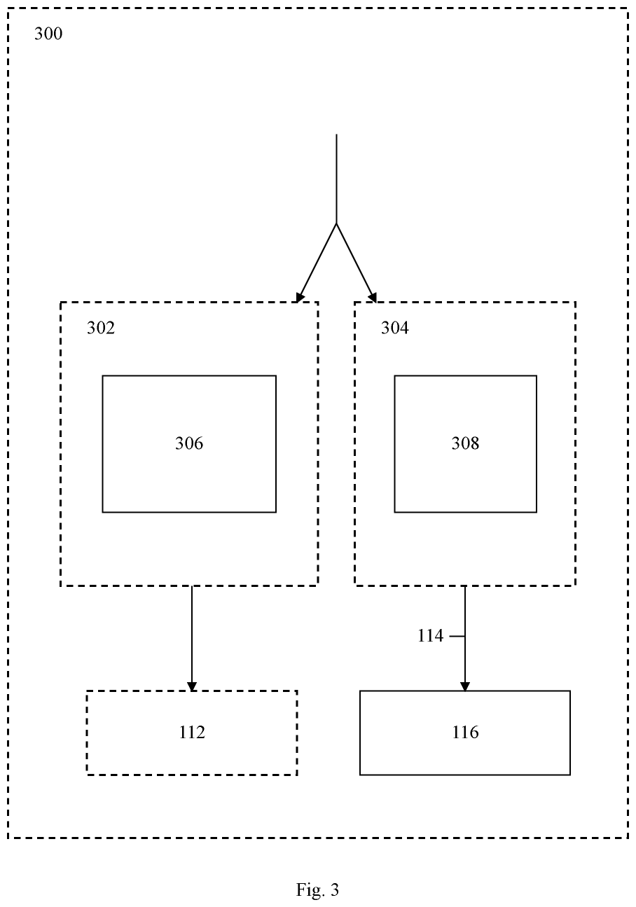

FIG. 3 illustrates a subspace decomposition 300. The eight-channel optical input space is separated into a seven-dimensional neutral compute subspace 302 and a one-dimensional DC balance subspace 304. The seven-dimensional neutral compute subspace 302 is associated with non-DC modes 306, including modes k=1 through k=7. The one-dimensional DC balance subspace 304 is associated with a DC mode 308, namely mode k=0. The non-DC modes 306 are routed to the one or more compute outputs 112. The DC mode 308 is routed to the balance output structure 114 and preferably to the dedicated balance port 116. Valid computation occurs in the neutral compute subspace 302, while the balance port 116 monitors the DC balance subspace 304.

In a disclosed 8-point transform implementation, the balance-port amplitude is dftBalancePortAmplitude(w)=(sum_{k=0}\hat{ }7 wk)/sqrt(8). The sqrt(8) term is a nonzero normalization factor. Accordingly, dftBalancePortAmplitude(w)=0 if and only if sum_{k=0}\hat{ }7 wk=0. Because ledger neutrality is defined by zero balance amplitude, the physical balance port 116 extracts the DC coefficient of the optical word 106, and the balance port 116 is null if and only if the word is ledger-neutral at the disclosed model level. The same physical structure may be described as isolating the channel sum, isolating a scaled channel sum, extracting a DC coefficient, routing a DC witness mode, or routing a summed balance witness component. These descriptions identify the same disclosed balance-witness function at different claim-support levels. This relationship supports claim language directed to a channel sum, a scaled DC coefficient, a DFT balance-port amplitude, a DC mode, a balance output structure, a balance output path, and a dedicated balance port.

The neutral compute subspace 302 is not merely an optional explanatory diagram. It is the disclosed compute region of the transform space. The non-DC modes 306 form the neutral compute subspace 302 because each non-DC mode is mean-free with respect to the DC balance witness, individually ledger-neutral at the disclosed model level, and nulls the DC balance-port coefficient. A ledger-neutral optical word lies in the span of the non-DC modes 306, while the DC mode 308 carries the balance witness. Computation that preserves neutrality remains in the neutral compute subspace 302. A word that leaks into the DC balance subspace 304 produces balance-port output at the balance output structure 114. Thus, the processor cell 100 uses physical optical routing to separate valid neutral compute content from the balance witness. This physical separation is a central feature of the disclosed architecture.

The compute-output structure may be implemented broadly, intermediately, or narrowly. At a broad level, the one or more compute outputs 112 carry non-balance optical content. At an intermediate level, the one or more compute outputs 112 collectively carry non-DC optical content separated from the DC witness component. At a narrower level, the one or more compute outputs 112 include seven non-DC mode outputs or paths corresponding to modes 1 through 7. The balance-output structure may likewise be implemented broadly, intermediately, or narrowly. At a broad level, the balance output structure 114 carries the DC or summed witness component. At an intermediate level, a balance output path, region, tap, waveguide, or optical branch carries the witness component toward detection. At a narrower level, the dedicated balance port 116 carries the disclosed DC witness component.

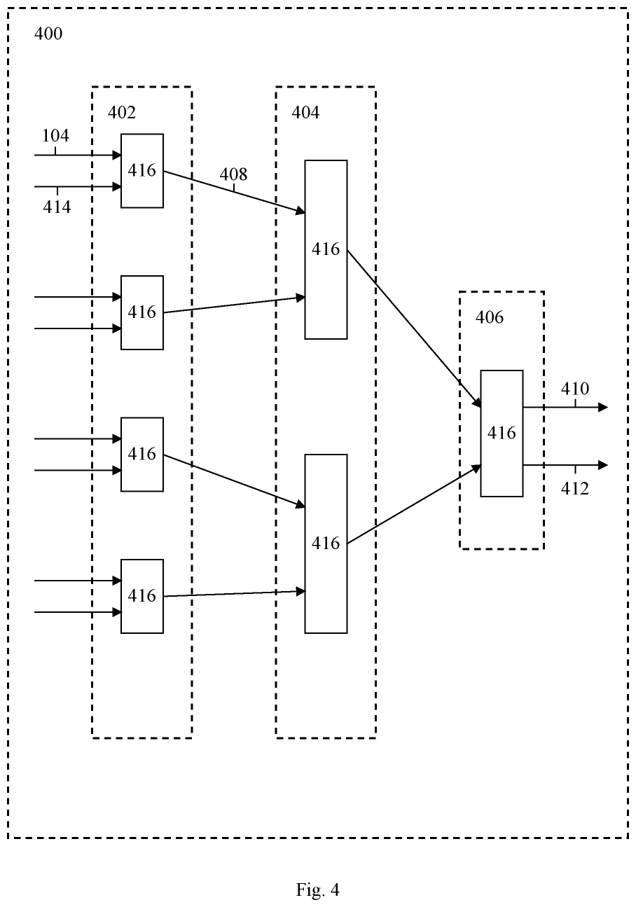

FIG. 4 illustrates a preferred interferometric implementation. The interferometric network 110 may be implemented as a three-stage multimode-interference coupler cascade 400. The cascade 400 includes a first stage 402, a second stage 404, and a third stage 406. The first stage 402 includes four 2×2 multimode-interference couplers 416 that pair inputs 1 and 2, inputs 3 and 4, inputs 5 and 6, and inputs 7 and 8. The second stage 404 includes two 2×2 multimode-interference couplers 416 that combine four intermediate optical paths 408. The third stage 406 includes a final coupler 416 that combines remaining optical paths and produces separated output content. A balance path 410 routes the DC or summed witness component toward the balance output structure 114 or dedicated balance port 116. Compute paths 412 route non-DC optical content toward the one or more compute outputs 112.

The cascade 400 is preferred because it provides a concrete integrated implementation of the disclosed 8-point interferometric transform. The optical phases, coupling ratios, path lengths, and routing of the cascade 400 may be selected so that the output corresponding to the DC coefficient is routed to the balance port 116. The remaining optical content is routed through compute paths 412 to the compute outputs 112. In this preferred arrangement, the balance path 410 is the optical path associated with the DC witness component, and the compute paths 412 are the optical paths associated with non-DC content.

The exact three-stage cascade 400 is not the only supported implementation of the interferometric network 110. The interferometric network 110 may more broadly include any integrated optical interference structure configured to isolate the DC or summed balance witness component of the eight-channel optical word 106 from non-balance optical content. The interferometric network 110 may include multimode-interference couplers, directional couplers, Mach-Zehnder interferometers, star couplers, slab couplers, arrayed waveguide structures, tree couplers, hybrid coupler networks, phase-shifter networks, or combinations of such structures. The routing geometry, coupling ratios, and phase-trim positions may vary, provided that the balance output structure 114 carries the DC or summed witness component used for imbalance detection.

In a preferred physical implementation, the waveguides 104 are single-mode silicon-nitride ridge waveguides 414 formed on a substrate 136. The substrate 136 may be a silicon-on-insulator substrate. A preferred waveguide cross-section is approximately 500 nm by 220 nm. A preferred operating wavelength is approximately 1550 nm. The waveguides 104 may be formed with propagation loss less than approximately 0.5 dB/cm at the operating wavelength. In a preferred embodiment, the optical path through the cascade 400 is approximately 0.8 cm or less, and total insertion loss from input to compute output is less than or equal to approximately 2.2 dB. In broader embodiments, insertion loss may be less than approximately 3 dB from input to compute output. These values are preferred implementation targets and not universal limitations.

The phase-shifter elements 108 may be positioned before the interferometric network 110, within the interferometric network 110, after one or more stages of the interferometric network 110, or along calibration-sensitive portions of the optical channels. In some embodiments, the phase-shifter elements 108 encode operand values by imposing selected phases on the eight channels. In some embodiments, the phase-shifter elements 108 trim optical path errors or phase imbalance. In some embodiments, one group of phase-shifter elements 108 performs data encoding, while another group performs calibration trimming. In some embodiments, a single phase-shifter element performs both functions depending on operating mode.

In preferred thermo-optic embodiments, the phase-shifter elements 108 include heater elements 132. The heater elements 132 may be formed from TiN, doped silicon, metal, resistive heater material, or another thermo-optic heating structure. In other embodiments, the phase-shifter elements 108 include electro-optic modulators, carrier-injection modulators, carrier-depletion modulators, lithium-niobate phase shifters, PZT phase shifters, MEMS phase shifters, or other phase-control devices. The phase-shifter elements 108 may be driven by phase-data lines, calibration lines, digital-to-analog converters, pulse-width-modulated drivers, current sources, voltage drivers, or other control circuitry.

FIG. 5 illustrates a balance-port detection path 500. The balance port 116 produces balance-port optical output 502. The detector 118 receives the balance-port optical output 502. In preferred embodiments, the detector 118 includes a balanced photodetector arrangement 504. The balanced photodetector arrangement 504 may include dual balanced photodiodes 140. The balanced photodiodes 140 may feed a differential transimpedance amplifier, a current subtractor, a comparator, an offset-correction circuit, a latch, a mixed-signal converter, or another detector readout circuit. The detector 118 produces a detector output 506. The detector output 506 is supplied to threshold logic 120, which compares the detector output 506 against the threshold level 210 or another threshold condition. When the threshold condition is satisfied, the threshold logic 120 asserts the imbalance signal 122.

The detector 118 may be implemented at several levels of breadth. At a broad level, the detector 118 is at least one optical detector optically coupled to the balance output structure 114. At an intermediate level, the detector 118 is a balanced photodetector arrangement 504 optically coupled to the balance output structure 114. At a narrower level, the detector 118 includes dual balanced InGaAs photodiodes 140 or dual balanced Ge-on-Si photodiodes optically coupled to the dedicated balance port 116. The detector 118 may be monolithically integrated, hybrid-integrated, bonded, flip-chip attached, located on a detector chiplet, or externally coupled through an optical path while remaining optically coupled to the balance output structure 114.

In a preferred detector embodiment, the photodiodes 140 have a responsivity of approximately 0.85 A/W, a bandwidth of approximately 10 GHz, and a dark current less than approximately 1 nA at approximately −1.8 V reverse bias. These values are representative examples. The photodiodes 140 may operate at other responsivity, bandwidth, bias, and dark-current values suitable for a target wavelength, platform, and detection threshold. A balanced detector arrangement may provide common-mode rejection and improved sensitivity to residual imbalance. A single photodiode may also be used in embodiments where common-mode rejection is not required or where calibration and thresholding otherwise provide adequate discrimination.

The threshold logic 120 may be implemented in multiple ways. In an analog embodiment, the detector output 506 is an analog current or voltage that is amplified by a transimpedance amplifier and compared with the threshold level 210 by an analog comparator. In a differential embodiment, the detector output 506 is a differential signal from the balanced photodetector arrangement 504, and common-mode optical or electrical content is rejected before threshold comparison. In a mixed-signal embodiment, the detector output 506 is amplified, sampled, converted, and compared digitally. In a digital embodiment, a digitized balance-output value is compared with a stored threshold. In a latch-based embodiment, the threshold logic 120 asserts and holds the imbalance signal 122 until cleared. In an interrupt embodiment, assertion of the imbalance signal 122 causes a processor interrupt. In a programmable-threshold embodiment, the threshold level 210 is stored in a register or supplied by a digital-to-analog converter. In a calibration embodiment, the threshold logic 120 may also provide calibration feedback to the calibration controller 130.

The threshold condition may be fixed, programmable, temperature-compensated, calibration-dependent, mode-dependent, or dynamically adjusted. The threshold level 210 may be selected based on detector noise floor, extinction target, residual calibration error, optical input power, expected imbalance magnitude, process corner, operating temperature, symbol rate, or desired false-trigger margin. In some embodiments, the threshold level 210 is stored in a register. In some embodiments, the threshold level 210 is generated by a digital-to-analog converter. In some embodiments, the threshold level 210 is adjusted during calibration. In some embodiments, different thresholds are used for test mode, calibration mode, and operational mode.

The threshold-logic function can be described at multiple levels. At a broad level, residual balance output is optically detected. At an intermediate level, detected balance output is compared against a threshold condition. At a narrower level, the imbalance signal 122 is generated when threshold<balancePower(w). The threshold is positive. The detector latency is positive. In preferred embodiments, detector latency is less than 5 ns. In one preferred embodiment, imbalance detection latency is approximately 4.8 ns. These timing values are preferred disclosed implementation targets and may be used as fallback limitations.

The detector soundness relation is part of the disclosed operation. Neutral words never trigger the flag, and flagged words are never neutral, at the disclosed model level and under the disclosed threshold predicate. In formal terms, ledgerNeutral(w) implies not imbalanceFlagHigh(w), and imbalanceFlagHigh(w) implies not ledgerNeutral(w). In calibrated physical embodiments, these formal statements are implemented through the design of the interferometric network 110, the calibration controller 130, the detector 118, the threshold logic 120, and the threshold level 210. Exact mathematical soundness is expressed at the model level. Practical soundness is implemented through calibration, extinction margin, detector sensitivity, and threshold qualification.

The balance-port output may therefore be described in three support tiers. In a formal-null tier, the balance-port amplitude is exactly zero at the disclosed model level. In an operational-null tier, the balance-port optical output 502 is substantially null or suppressed in a calibrated physical embodiment. In a threshold-qualified tier, the balance-port optical output 502 does not trigger the imbalance signal 122 because it does not satisfy the implemented threshold condition. These tiers support claim language directed to formal nulls, substantially null physical outputs, and threshold-qualified accepted outputs.

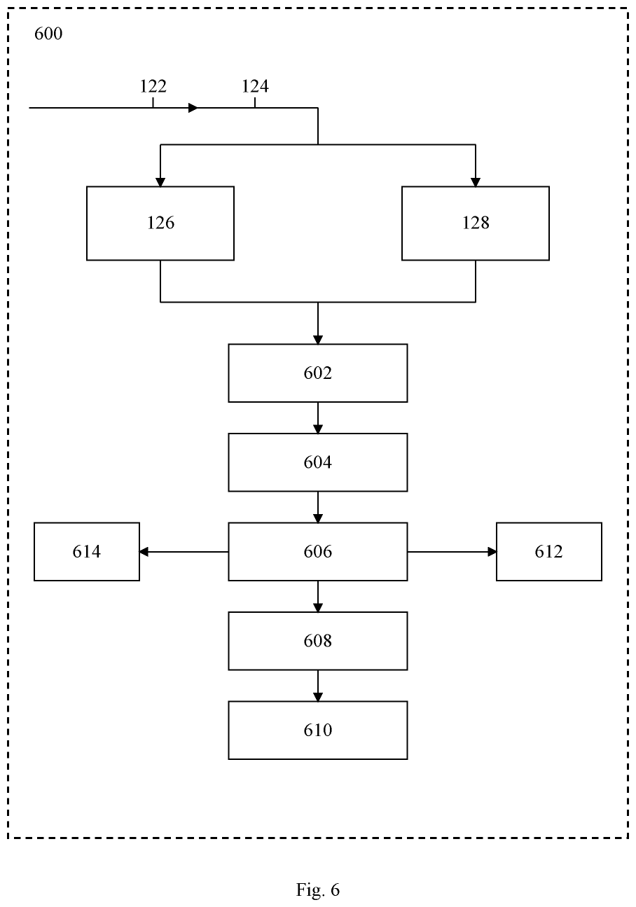

FIG. 6 illustrates a computation-control workflow 600. The imbalance signal 122 is communicated along the control path 124 to the processor 126, rollback controller 128, or another computation-control structure. The control workflow 600 may include an invalidation step 602, a stall step 604, a rewind step 606, a rollback step 608, a re-execution step 610, a checkpoint restoration step 612, and an exception-handling step 614. These steps may be used individually or in combination. The workflow 600 may be implemented in a processor pipeline, accelerator controller, digital state machine, microcontroller, firmware-controlled system, programmable logic, mixed-signal controller, or external system controller.

At a broad level, the computation-control workflow 600 uses the imbalance signal 122 as an indication that a balance condition has failed. At an intermediate level, the workflow 600 gates, suppresses, qualifies, delays, marks, or conditions a computation or result based on the imbalance signal 122. At a narrower level, the workflow 600 performs invalidation, stall, rewind, rollback, re-execution, checkpoint restoration, selective replay, or exception handling. In one embodiment, a result generated during a flagged optical word is not committed. In another embodiment, a downstream latch is disabled. In another embodiment, a writeback operation is suppressed. In another embodiment, an exception vector is generated. In another embodiment, a photonic accelerator lane is halted. In another embodiment, a recalibration request is generated. In another embodiment, the imbalance signal 122 qualifies a result by marking the result as suspect while permitting a supervisory controller to determine whether to replay, discard, or accept the result under a higher-level policy.

In a preferred rollback workflow, the detector 118 detects residual balance-port optical output 502, the threshold logic 120 asserts the imbalance signal 122, and the processor 126 prevents commitment of the current result. The rollback controller 128 stalls the pipeline within one clock cycle, invalidates the current instruction result, rewinds operand registers or working state to a last neutral state, and re-executes the operation with corrected operands, corrected phase settings, or corrected control state. In one preferred implementation, rollback completes in 3 processor cycles at 200 MHz, corresponding to approximately 15 ns. This preferred rollback timing is a fallback implementation target and is not required in every embodiment.

The control path 124 may be implemented as a wire, trace, metal interconnect, on-chip signal route, differential electrical connection, logic net, interrupt line, status bus, sideband bus, memory-mapped status register, serial management interface, or other communication path. The imbalance signal 122 may be a CMOS output, open-drain output, differential output, current-mode output, latched flag, pulse, interrupt, status bit, or encoded status signal. The processor 126 may be an electronic processor, photonic processor, mixed-signal processor, accelerator, finite-state machine, control processor, neural-network accelerator, quantum-control processor, or transaction-verification engine.

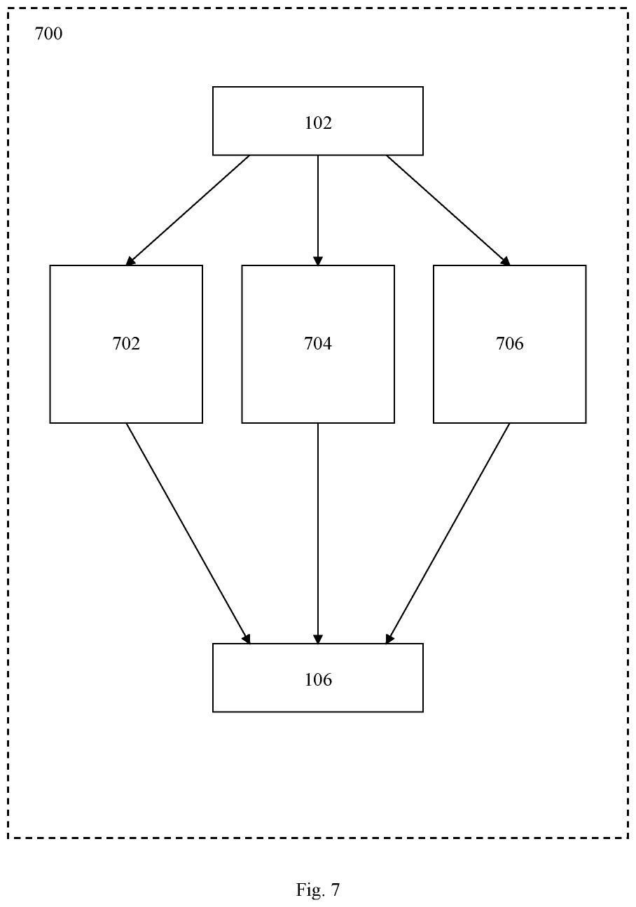

FIG. 7 illustrates operand encoding options 700. In a binary encoding 702, logical +1 and logical −1 values are represented by binary phase-shift-keyed optical phases. For example, logical +1 may be represented by phase 0, and logical −1 may be represented by phase pi. A binary word having four +1 amplitudes and four −1 amplitudes has zero balance amplitude. A representative neutral word is [+1, −1, +1, −1, +1, −1, +1, −1], for which the balance amplitude is 4*(+1) +4*(-1) =0. The balance power is zero at the disclosed model level, and the imbalance signal 122 remains low under threshold-qualified operation.

A representative non-neutral binary word is [+1, +1, +1, +1, −1, −1, −1, +1], for which the balance amplitude is 5*(+1) +3*(−1)=+2. The balance power is positive. The interferometric network 110 routes the resulting DC witness component to the balance output structure 114 or dedicated balance port 116. The detector 118 detects residual balance-port optical output 502. The threshold logic 120 may then assert the imbalance signal 122. This example illustrates how a single-channel deviation or other imbalance can be detected in the optical domain.

In a multilevel encoding 704, the optical word 106 may use multilevel phase-shift-keyed or quadrature-amplitude encoded channel values. Valid multilevel codewords are selected so that the complex amplitudes sum to zero. In a root-of-unity carrier encoding 706, the eight channels may carry canonical carrier values exp(2pii*k/8) for k=0 through 7. The sum of those carrier values is zero. Root-of-unity carrier encoding 706 directly illustrates the eight-tick cancellation relation. The encoding options 700 provide support for narrower claim positions but are not required for the broad architecture unless recited.

The processor cell 100 may receive the optical word 106 from external modulators, on-chip modulators, upstream waveguides, optical fibers, photonic interposers, grating couplers, edge couplers, laser sources, coherent optical sources, or other optical input structures. In some embodiments, the eight optical inputs 102 receive eight separate optical carriers. In some embodiments, a common optical carrier is split into eight branches and independently phase shifted. In some embodiments, amplitude and phase modulation are both used. In some embodiments, the optical word 106 represents operand values, syndrome values, parity values, neural-network row values, transaction word values, or other eight-channel data.

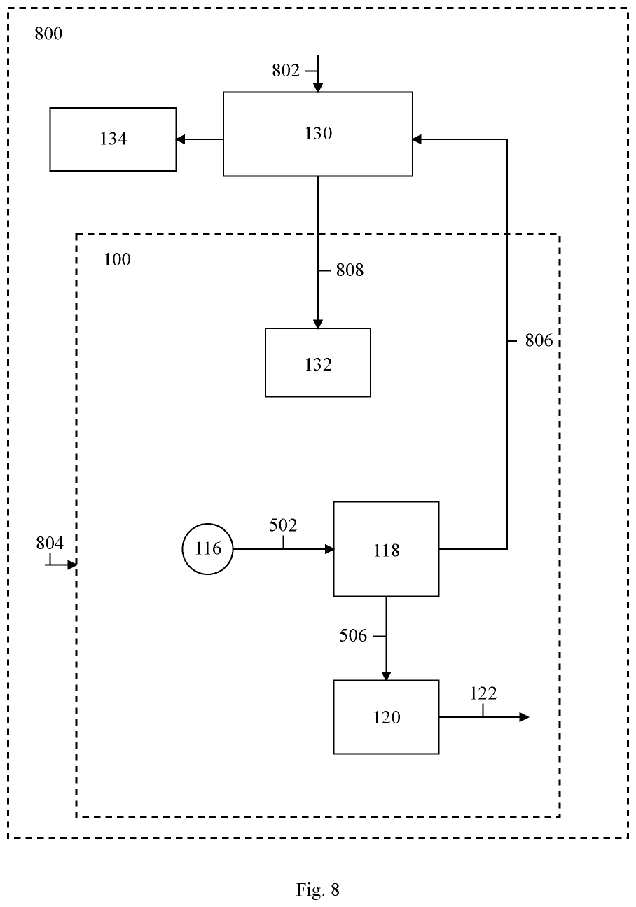

FIG. 8 illustrates thermal calibration and phase trimming 800. In practical physical embodiments, fabrication variation, optical path-length mismatch, coupler imbalance, heater resistance variation, thermal drift, wavelength drift, detector offset, package stress, and aging may reduce suppression at the balance port 116. A calibration controller 130 compensates for these effects by adjusting the phase-shifter elements 108 or heater elements 132. The calibration controller 130 may monitor balance-port optical output 502, detector output 506, the imbalance signal 122, an analog detector value, a differential detector value, or an auxiliary calibration output.

In a preferred calibration sequence, a calibration trigger 802 initiates calibration. The processor cell 100 applies or receives a known neutral input pattern 804. The detector 118 provides detector feedback 806 corresponding to residual balance-port output. The calibration controller 130 adjusts heater control states 808 associated with the heater elements 132. The calibration controller 130 iteratively searches for a trim state that reduces or minimizes balance-port optical output 502. The resulting trim state is stored in trim memory 134. The calibration controller 130 periodically refreshes the trim state to compensate for temperature drift, aging, and operating-condition changes.

The calibration controller 130 may be implemented as a successive-approximation register controller, finite-state machine, digital calibration engine, mixed-signal control loop, microcontroller, firmware routine, analog feedback circuit, or externally supervised controller. In a preferred embodiment, the calibration controller 130 uses 8-bit resolution per heater element 132. Calibration time is less than approximately 200 microseconds for eight heaters, corresponding to approximately 25 microseconds per heater in one implementation. The calibration refresh interval is approximately 10 ms, corresponding to approximately 100 Hz refresh. These values are preferred implementation targets.

The calibration controller 130 may perform initial calibration at power-up, periodic calibration during operation, event-triggered calibration after a large residual balance output, temperature-triggered calibration after a temperature change, mode-change calibration after a change in operating wavelength or encoding, or diagnostic calibration during test. The calibration controller 130 may store one trim state or multiple trim states. Multiple trim states may correspond to temperature ranges, optical wavelengths, symbol rates, supply-voltage ranges, operating modes, or input-power levels. In an array embodiment, trim states may be stored per processor cell 100, per channel, per group of cells, per row, per column, per block, or per operating mode.

In one preferred symmetry budget, waveguide fabrication variation contributes approximately +/−0.3 percent, heater resistance variation contributes approximately +/−0.1 percent, and thermal drift with refresh contributes approximately +/−0.05 percent. The combined symmetry error is less than or equal to approximately +/−0.4 percent. Under calibrated neutral conditions, residual balance-port output is preferably more than 30 dB below input. In one preferred embodiment, the balance-port extinction ratio is approximately 30.5 dB. The preferred operating temperature range is approximately −20 C to +85 C. These values support preferred embodiments and fallback claims without limiting the broad architecture.

The calibration controller 130 may also compensate detector offset. For example, the processor cell 100 may measure detector output 506 under a dark condition, under a known neutral condition, and under a known imbalance condition. The threshold logic 120 may then set or update the threshold level 210 based on detector offset, dark current, common-mode level, optical input power, operating temperature, and stored trim state. In some embodiments, calibration includes verifying that neutral words do not trigger the imbalance signal 122 and verifying that selected non-neutral test words do trigger the imbalance signal 122. In some embodiments, the calibration controller 130 records a calibration quality value, extinction estimate, detector-offset value, or threshold margin. If calibration fails, the processor cell 100 may assert a diagnostic flag, request service, disable a lane, raise an exception, reduce symbol rate, enter a safe mode, request recalibration, or fall back to a redundant cell.

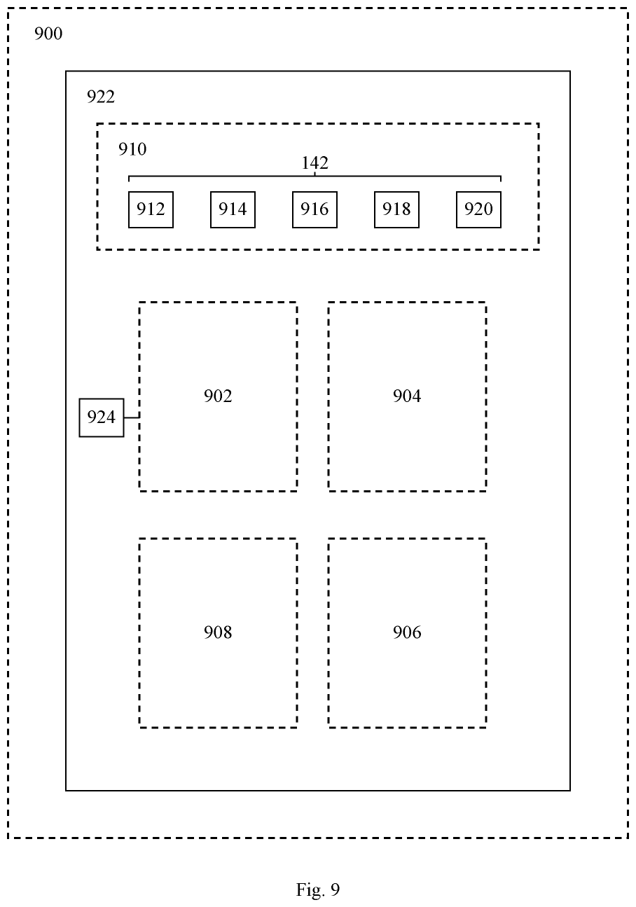

FIG. 9 illustrates an electrical interface and die layout 900. The die layout 900 includes an optical routing region 902, an interferometric network region 904, a detector region 906, a calibration-control region 908, and a pad region 910. Electrical pads 142 may include phase-data inputs PH_DATA[7:0] 912, an imbalance output IMB_PH 914, a calibration trigger input CAL_TRIG 916, a compute output interface COMP_OUT 918, and power pads 920. The phase-data inputs PH_DATA[7:0] 912 may be differential phase-drive lines, may have approximately 50 ohm impedance, and may use an approximately 3.3 V swing in a preferred implementation. The phase-data inputs PH_DATA[7:0] 912 may drive the phase-shifter elements 108 or associated driver circuits. The imbalance output IMB_PH 914 carries the imbalance signal 122 and may be a CMOS active-high output. The calibration trigger input CAL_TRIG 916 initiates calibration. The compute output interface COMP_OUT 918 may represent an optical output, analog output, detector output, fiber-coupled output, or photonic routing interface depending on implementation.

In one preferred electrical implementation, the power pads 920 include a V_LOGIC rail at approximately 1.2 V, a V_HEATER rail at approximately 3.3 V, and a V_PD detector bias rail at approximately −1.8 V. A preferred logic current is approximately 15 mA. A preferred heater current is approximately 22 mA, with heaters duty-cycled to approximately 15 percent. A preferred photodiode bias current is approximately 0.5 mA. Preferred total power is approximately 96 mW per cell. In broader embodiments, total cell power may be less than approximately 200 mW. These values are preferred implementation targets and fallback support.

The die 922 may have a preferred footprint of approximately 1.2 mm by 1.2 mm, corresponding to approximately 1.44 mm 2 per processor cell 100. In broader embodiments, die area may be less than approximately 2 mm 2 per cell. In a preferred manufacturing example, a 4-inch wafer yields more than 4000 processor cells 100. The processor cell 100 may be packaged in a CLCC-20 ceramic package, a ceramic leadless chip carrier, flip-chip package, photonic multi-chip module, interposer package, board-level photonic module, or other package. A fiber V-groove 924 may be used to couple optical signals to or from the processor cell 100. Other optical coupling structures may include grating couplers, edge couplers, lensed fibers, fiber arrays, photonic interposer waveguides, board-level waveguides, or co-packaged optical interfaces.

The electrical interface may include additional optional signals. For example, the processor cell 100 may include a reset input, enable input, calibration-done output, calibration-failed output, diagnostic analog output, serial control interface, threshold-programming input, test-mode input, cell-address input, array-row select, array-column select, scan-chain connection, or status register interface. Such signals are optional and may be included to support product, module, array, or system embodiments. A packaged module may include one or more processor cells 100, optical coupling structures, detector bias circuitry, threshold circuitry, calibration memory, thermal sensors, and management circuitry. The core balance-witness function does not require all such interface features.

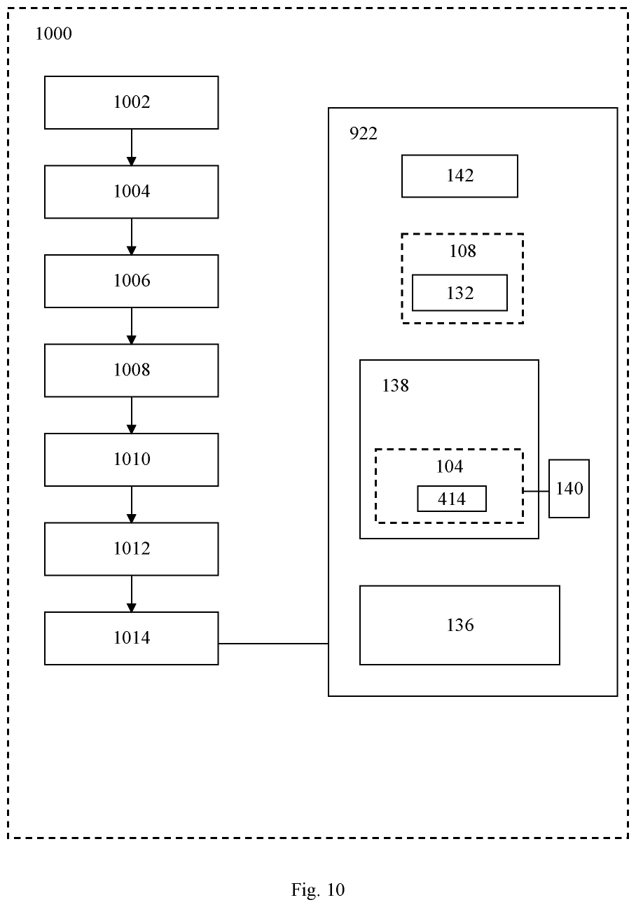

FIG. 10 illustrates a fabrication structure and process flow 1000. A preferred fabrication process begins with SOI wafer preparation 1002. The substrate 136 may include a silicon device layer, a buried oxide layer, and a photonic layer. In one embodiment, the substrate 136 comprises a 220 nm silicon-on-insulator structure on an approximately 2 micrometer buried oxide layer. The wafer may be cleaned using RCA-1, RCA-2, and deionized-water rinse steps. Waveguide patterning 1004 may be performed using 193 nm deep-ultraviolet immersion lithography with a photoresist layer, such as a 248 nm photoresist having an approximately 300 nm thickness, followed by ICP-RIE etching. In a preferred etch implementation, C4F8/SF6 chemistry is used to perform an approximately 220 nm full etch. The target ridge waveguide geometry may be approximately 500 nm by 220 nm. Propagation loss may be less than approximately 0.5 dB/cm at approximately 1550 nm.

A cladding step 1006 deposits a cladding layer 138. The cladding layer 138 may be PECVD silicon dioxide. In one preferred embodiment, the cladding layer 138 is approximately 1.5 micrometers thick and is deposited at approximately 300 C. Chemical-mechanical polishing may planarize the cladding layer 138 to within approximately +/−5 nm. A heater fabrication step 1008 deposits and patterns heater material over phase-shifter sections. The heater material may be TiN. In one embodiment, the heater elements 132 are approximately 100 nm thick and approximately 30 micrometers by 2 micrometers in lateral dimension. Contacts may include Ti/Al layers, for example approximately 10 nm Ti and 200 nm Al.

A photodiode integration step 1010 integrates the photodiodes 140 at or near the balance port 116. In one embodiment, InGaAs detector dies are bonded into recesses using Au-Au thermocompression bonding at approximately 250 C. In another embodiment, Ge-on-Si photodiodes are formed or integrated for CMOS-compatible detector integration. Wire bonding may use Al wedge bonds to on-chip pads. A metallization step 1012 forms interconnect and bond pads. In one embodiment, a first metal stack includes Ti/Al/TiN layers of approximately 10 nm, 500 nm, and 50 nm, and a second metal layer includes Al/Cu bond pads of approximately 400 nm. A passivation layer, such as SiN of approximately 200 nm, may be deposited and opened by reactive-ion etching. A dicing and packaging step 1014 separates the die 922 and packages the processor cell 100.

The fabrication flow 1000 is representative. Other lithography tools, etch chemistries, deposition methods, metallization stacks, passivation systems, bonding methods, detector-integration methods, and package types may be used. Alternative photonic material platforms may include silicon nitride on insulator, silicon photonics, silicon-on-sapphire, thin-film lithium niobate, hybrid silicon-lithium-niobate structures, III-V photonics, or other integrated photonic platforms. Alternative detector integrations may include bonded III-V detectors, germanium detectors, detector chiplets, off-chip detectors, edge-coupled external detectors, grating-coupled external detectors, or hybrid photonic/electronic assemblies. Alternative phase-control structures may include thermo-optic heaters, electro-optic modulators, carrier-based modulators, MEMS phase shifters, or other phase-control devices. These alternatives are acceptable so long as the resulting structure preserves the disclosed eight-input balance-witness function in which the DC or summed witness component is routed to the balance output structure 114 and residual balance output is used to generate the imbalance signal 122.

The fabrication method supports a separate claim family. A fabrication method may include preparing the substrate 136, patterning the waveguides 104, forming the cladding layer 138, forming the phase-shifter elements 108 or heater elements 132, integrating the photodiodes 140, forming metallization and electrical pads 142, and packaging the die 922. The fabrication method may further include optically coupling the balance port 116 to the detector 118, electrically coupling the detector 118 to the threshold logic 120, and configuring the calibration controller 130 to adjust the phase-shifter elements 108 based on balance-port optical output 502.

Preferred implementation targets provide additional support for fallback claim positions. In some embodiments, balance-port extinction under a calibrated neutral input is at least approximately 25 dB. In a preferred embodiment, balance-port extinction is approximately 30.5 dB. In some embodiments, symbol rate is at least approximately 10 MS/s. In a preferred embodiment, symbol rate is approximately 40 MS/s. In some embodiments, total cell power is less than approximately 200 mW. In a preferred embodiment, total cell power is approximately 96 mW. In some embodiments, die area is less than approximately 2 mm 2 per cell. In a preferred embodiment, die area is approximately 1.44 mm2 per cell. In some embodiments, imbalance detection latency is less than approximately 5 ns. In a preferred embodiment, imbalance detection latency is approximately 4.8 ns. In a preferred system implementation, rollback completes in approximately 3 cycles at 200 MHz, or approximately 15 ns. In a preferred array implementation, 64 cells operating at 40 MS/s provide 2560 MS/s, or 2.56 GS/s, aggregate throughput. In a preferred calibration implementation, total symmetry error is maintained at less than or equal to approximately +/−0.4 percent across approximately −20 C to +85 C. These values are disclosed preferred implementation targets and worked-example values, not universal requirements unless expressly recited in a claim.

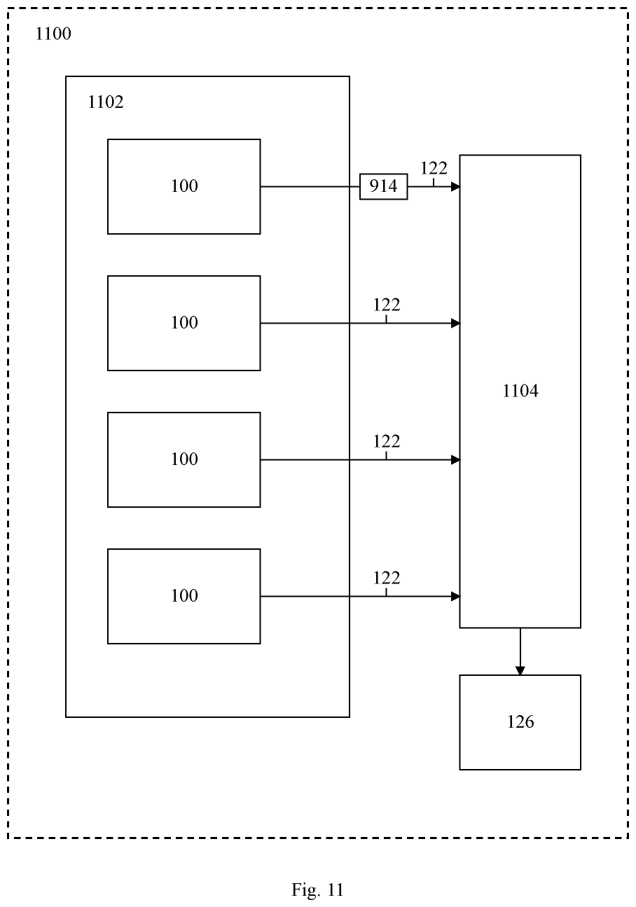

FIG. 11 illustrates a multi-cell array and processor integration embodiment 1100. A plurality of processor cells 100 may be arranged in an array 1102. The array 1102 may be formed on a single die, across multiple photonic chiplets, on a photonic interposer, in a multi-chip module, or in another package. The array 1102 may include shared optical input routing, shared laser input, shared calibration control, shared detector biasing, shared power distribution, shared digital control, shared clocking, shared thermal sensing, or shared output aggregation. In one preferred embodiment, the array 1102 includes 64 processor cells 100. If each processor cell 100 operates at approximately 40 MS/s, the aggregate throughput is approximately 64*40 MS/s=2560 MS/s =2.56 GS/s.

The array 1102 may be coupled to control logic 1104. The control logic 1104 may receive multiple imbalance signals 122, combine imbalance signals, prioritize error responses, identify a failing cell, isolate a failing optical lane, suppress a writeback, coordinate rollback, request recalibration, or report status to the processor 126. In some embodiments, each processor cell 100 has a separate imbalance output IMB_PH 914. In other embodiments, multiple cells share an aggregated imbalance output. In still other embodiments, imbalance outputs are encoded into a status bus, interrupt line, exception vector, diagnostic register, scan chain, or management interface.

The array 1102 may be used in a balanced arithmetic accelerator, fault-tolerant processor, neural-network accelerator, quantum syndrome checker, transaction verifier, or other optical-domain checking system. In a balanced arithmetic accelerator, one or more processor cells 100 check algebraic balance during finite-field arithmetic, cryptographic arithmetic, error-correcting-code verification, hash computation, or other algebraically constrained operations. In a fault-tolerant processor, the processor cell 100 is coupled to a processor pipeline and checks selected operand values, result values, or instruction-word components before commitment. In a self-checking neural-network engine, matrix-vector multiplication is accompanied by balance checking of preconditioned rows, output vectors, or intermediate optical words. In a quantum syndrome checker, eight-element syndrome words are supplied to the eight optical inputs 102, and the imbalance signal 122 indicates syndrome imbalance. In an optical transaction verifier, data is decomposed into eight-element balanced words and checked optically by one or more processor cells 100.

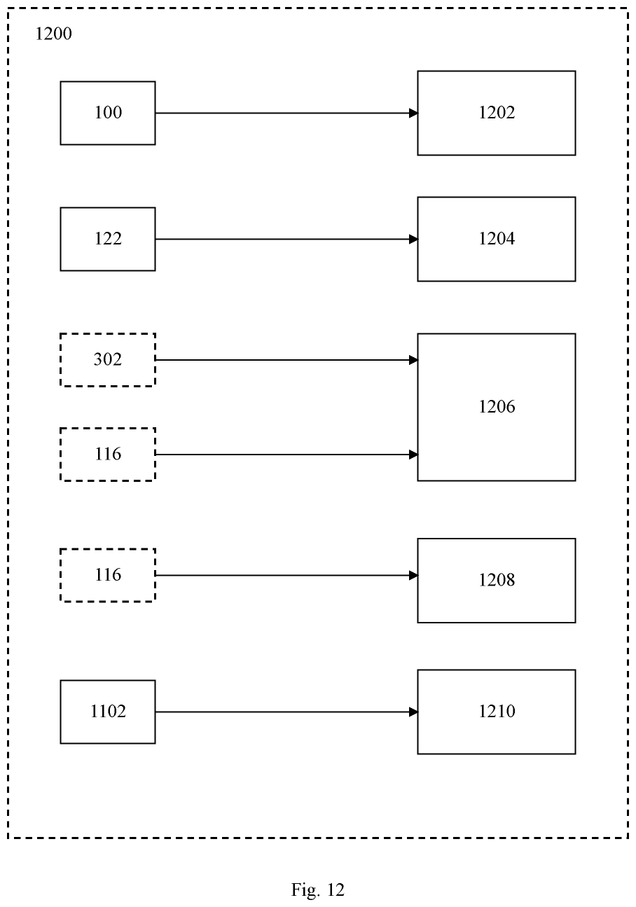

FIG. 12 illustrates downstream application embodiments 1200. A balanced arithmetic accelerator 1202 uses the processor cell 100 to check arithmetic balance. A photonic fault-tolerant processor 1204 uses the imbalance signal 122 to gate commitment, suppress writeback, request replay, or initiate exception handling. A self-checking photonic neural-network engine 1206 uses the neutral compute subspace 302 and the balance port 116 to detect hardware-induced computation errors. A quantum syndrome checker 1208 uses the balance port 116 as an optical witness of syndrome neutrality. An optical transaction verifier 1210 uses the array 1102 to verify structural balance of transaction words. These downstream embodiments are subordinate examples of use environments and do not displace the core identity of the invention as the eight-input DC-witness photonic processor architecture.

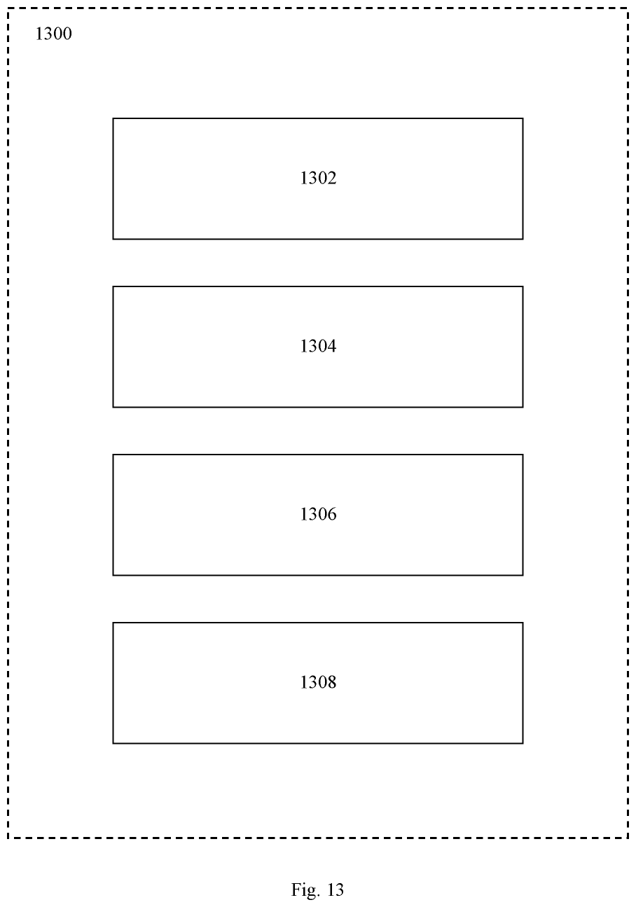

FIG. 13 illustrates optional alternative and prophetic configurations 1300. Alternative photonic implementations 1302 may use silicon nitride, silicon photonics, silicon-on-sapphire, thin-film lithium niobate, hybrid silicon-lithium-niobate platforms, or other integrated photonic materials. Alternative detector arrangements 1304 may use InGaAs photodiodes, Ge-on-Si photodiodes, balanced detector pairs, single detectors, off-chip detectors, detector chiplets, or hybrid-integrated detectors. Alternative phase-shifter structures 1306 may use TiN heaters, doped-silicon heaters, electro-optic phase shifters, lithium-niobate modulators, PZT phase shifters, carrier-injection modulators, carrier-depletion modulators, MEMS phase shifters, or other optical phase-control devices. Prophetic extended-channel configurations 1308 may include sixteen-input or sixteen-point transform variants. Such extended-channel configurations are future-facing and subordinate to the disclosed eight-input architecture unless separately supported.

Several worked examples illustrate operation of the disclosed architecture. In a first example, the optical word 106 is a binary neutral word having amplitudes [+1, −1, +1, −1, +1, −1, +1, −1]. The balance amplitude is 4*(+1)+4*(−1)=0. The balance power is zero at the disclosed model level. The balance port 116 is formally null. In a calibrated physical embodiment, the balance-port optical output 502 is suppressed below the threshold level 210, and the imbalance signal 122 remains low.

In a second example, the optical word 106 is a binary non-neutral word having amplitudes [+1, +1, +1, +1, −1, −1, −1, +1]. The balance amplitude is 5*(+1) +3*(-1) =+2. The balance power is positive. The interferometric network 110 routes the DC witness component to the balance output structure 114 or dedicated balance port 116. The detector 118 detects residual balance-port optical output 502. The threshold logic 120 may assert the imbalance signal 122 if the detected output satisfies the threshold condition. The processor 126 may then suppress the result, initiate rollback, request recalibration, raise an exception, or otherwise control computation.

In a third example, the optical word 106 uses root-of-unity carrier encoding. The kth channel carries wk=exp(2pii*k/8) for k=0 through 7. The sum of the eight channel amplitudes is zero. The balance amplitude is zero. The balance power is zero. This example illustrates the eight-tick cancellation relation and its hardware realization by the balance port 116. The example also supports the relation between the eight-channel input structure, the DC witness component, and the null condition at the balance port 116.

In a fourth example, each of the eight input waveguides receives approximately 1 mW of optical input power. Total input power is approximately 8 mW, or approximately +9 dBm. If calibrated balance-port extinction is approximately 30.5 dB, balanced-state balance-port power is suppressed by approximately 30.5 dB relative to total input. In one illustrative calculation, a +9 dBm input level and 30.5 dB suppression correspond to a calibrated balanced-state residual level at the balance port 116 of approximately −21.5 dBm, or approximately 7.1 microwatts. In this illustrative example the detector noise floor is approximately −30 dBm, corresponding to approximately 1 microwatt, so that the calibrated balanced-state residual sits approximately 8.5 dB above the detector noise floor and is therefore optically detectable. The implemented imbalance threshold level 210 is selected above the calibrated balanced-state residual level and below expected non-neutral residual levels, so that calibrated neutral words do not assert the imbalance signal 122 and non-neutral words producing residual levels above the implemented threshold do assert the imbalance signal 122. The threshold level 210 may be selected based on detector noise, calibration tolerance, accepted-neutrality criteria, optical input power, and expected imbalance magnitude. This example provides preferred implementation support and does not require every embodiment to use the same input power, residual level, noise floor, or threshold.

In a fifth example, the array 1102 includes 64 processor cells 100 operating at approximately 40 MS/s each. The aggregate throughput is 64*40 MS/s=2560 MS/s, or 2.56 GS/s. In a sixth example, the calibration controller 130 applies the known neutral input pattern 804, monitors detector feedback 806, adjusts heater control states 808 using a successive-approximation process, stores the resulting trim state in trim memory 134, and refreshes the trim state approximately every 10 ms. In a seventh example, the non-neutral optical word 208 causes the imbalance signal 122 to assert after approximately 4.8 ns. The rollback controller 128 stalls the processor 126, invalidates the current result, rewinds to a last neutral state, and re-executes the operation. In a preferred implementation, rollback completes in approximately 15 ns.

Formal verification may support the disclosed architecture. In a disclosed Lean 4 formalization, the proof module compiles with zero sorry placeholders. The optical word 106 is modeled as a function from eight channel indices to complex amplitudes. The balance amplitude is defined as the sum of the eight channel amplitudes. The balance power is defined as the squared modulus of the balance amplitude. Ledger neutrality is defined by zero balance amplitude. The formalization proves that balancePower(w)>=0 and that balancePower(w)=0 if and only if ledgerNeutral(w). The formalization also proves that the DFT balance-port amplitude equals the scaled channel sum, that dftBalancePortAmplitude(w)=0 if and only if ledgerNeutral(w), that non-DC modes are neutral, that non-DC modes null the balance-port coefficient, and that a neutral signal lies in the span of non-DC modes. The formalization further proves that neutral words never trigger the imbalance flag and that flagged words are never neutral. Preferred-embodiment proof targets include preferred_detector_sub5ns, preferred_calibration_subpercent, preferred_extinction_target, preferred_symbol_rate_target, preferred_power_target, preferred_area_target, preferred_rollback_within_15ns, and preferred_array_throughput. A master viability certificate may bundle eight-tick carrier neutrality, DFT balance-port null behavior, sub-5 ns detection, at least 30 dB extinction, coherence exponent equal to 5, phi\hat{ }2=phi+1, and eight-tick sampling-window existence into a single formally verified conjunction. These formal verification results support the disclosed balance-witness architecture, but the structural invention remains the integrated photonic processor cell 100 and its optical-domain separation and detection of the balance witness.

The apparatus claim support may be understood as a ladder. A broad apparatus includes eight optical channels carrying the optical word 106, the interferometric network 110 configured to isolate a DC or summed balance witness component from non-balance optical content, the balance output structure 114 carrying the witness component, one or more compute outputs 112 carrying non-balance optical content, and the detector 118 configured to generate the imbalance signal 122. An intermediate apparatus includes the interferometric network 110 configured to separate non-DC content from a DC witness component, a balance output path or region carrying the DC witness component toward detection, and compute-output structure carrying non-DC content. A narrower apparatus includes eight waveguides 104, an 8-point interferometric transform, the dedicated balance port 116 carrying dftBalancePortAmplitude(w)=(sum_{k=0} \hat{ }7 wk)/sqrt(8), compute paths 412 corresponding to non-DC modes 306, and the balanced photodetector arrangement 504.

The method claim support may also be understood as a ladder. A broad method includes receiving eight optical channels, interferometrically processing the channels to isolate a DC or summed balance witness component from non-balance optical content, routing the balance witness component to the balance output structure 114, optically detecting residual balance output, and generating the imbalance signal 122. An intermediate method includes comparing detected balance output against a threshold condition and using the imbalance signal 122 to modify, gate, suppress, or qualify computation. A narrower method includes implementing an 8-point interferometric transform, routing non-DC modes 306 to the one or more compute outputs 112, routing the DC mode 308 to the dedicated balance port 116, detecting whether threshold<balancePower(w), and initiating invalidation, stall, rewind, rollback, re-execution, checkpoint restoration, selective replay, or exception handling.

The product and module embodiments support additional claim families. A packaged photonic module may include the processor cell 100, electrical pads 142, optical coupling structures, detector bias circuitry, threshold logic 120, and calibration circuitry. A processor checker module may include one or more processor cells 100 and control logic 1104 configured to generate one or more imbalance signals 122 for a processor 126. A multi-cell photonic module may include the array 1102 and shared calibration, bias, routing, or control circuitry. A system may include the processor cell 100, the processor 126, and the rollback controller 128 or another computation-control structure.

The disclosed architecture may be varied without departing from the central teaching. The optical inputs 102 may be edge-coupled, grating-coupled, fiber-coupled, interposer-coupled, generated on-chip, or supplied by another optical source. The compute outputs 112 may be optical outputs, detector-coupled outputs, analog outputs, digital outputs after detection, or routed photonic paths. The balance output structure 114 may terminate at an on-chip detector, off-chip detector, hybrid-integrated detector, monitoring tap, or diagnostic output. The threshold logic 120 may be analog, digital, mixed-signal, programmable, latched, interrupt-generating, or calibration-assisted. The calibration controller 130 may be local, shared, periodic, event-triggered, firmware-assisted, or externally controlled. The phase-shifter elements 108 may encode data, trim phase, or both. The processor 126 may be electronic, photonic, mixed-signal, hybrid, general-purpose, special-purpose, or accelerator-based.

The disclosed invention therefore provides a processor cell 100 in which the eight-channel optical word 106 is physically separated into a balance-witness component and non-balance compute content. The balance port 116 is null if and only if the word is ledger-neutral at the disclosed model level. The physical balance port 116 extracts the DC coefficient of the optical word 106. Valid computation occurs in the neutral compute subspace 302. The balance port 116 is a passive and continuous witness of ledger neutrality at the optical architecture level, before downstream detector and control latency. Residual balance-port power above threshold generates the imbalance signal 122. Neutral words never trigger the flag, and flagged words are never neutral at the disclosed model level. The disclosed architecture therefore supports broad claims directed to isolating and detecting a DC or summed balance witness, intermediate claims directed to a DC-isolating interferometric network and balance output path, and narrower claims directed to an 8-point transform, a dedicated balance port, non-DC neutral compute modes, balanced photodetection, calibration, and rollback. The preferred hardware stack, calibration scheme, detector path, electrical interface, fabrication flow, examples, and downstream embodiments provide concrete support and fallback positions while preserving the central identity of the invention as an eight-input integrated photonic DC-witness balance-enforcement architecture.

What is claimed is:

1. An integrated photonic processor cell comprising eight optical inputs configured to receive an eight-channel optical word; an interferometric network optically coupled to the eight optical inputs and configured to isolate a DC or summed balance witness component of the eight-channel optical word from non-balance optical content; a balance output structure optically coupled to the interferometric network and configured to carry the DC or summed balance witness component; one or more compute outputs optically coupled to the interferometric network and configured to carry the non-balance optical content; and a detector optically coupled to the balance output structure and configured to generate an electrical imbalance signal in response to residual optical output at the balance output structure satisfying a threshold condition.

2. The integrated photonic processor cell of claim 1, wherein the balance output structure comprises a dedicated balance port carrying a DC coefficient of the eight-channel optical word.

3. The integrated photonic processor cell of claim 1, wherein an amplitude at the balance output structure corresponds to a scaled sum of eight channel amplitudes of the eight-channel optical word.

4. The integrated photonic processor cell of claim 3, wherein the amplitude at the balance output structure is zero if and only if the eight-channel optical word is ledger-neutral at a disclosed model level.

5. The integrated photonic processor cell of claim 1, wherein the interferometric network is configured to separate an eight-channel optical input space into a seven-dimensional neutral compute subspace and a one-dimensional DC balance subspace.

6. The integrated photonic processor cell of claim 5, wherein the one or more compute outputs carry non-DC optical content corresponding to modes of the seven-dimensional neutral compute subspace.

7. The integrated photonic processor cell of claim 1, wherein the interferometric network comprises an 8-point interferometric transform configured to route a DC mode to the balance output structure and route one or more non-DC modes to the one or more compute outputs.

8. The integrated photonic processor cell of claim 7, wherein the 8-point interferometric transform is implemented by a three-stage cascade of 2×2 multimode-interference couplers.

9. The integrated photonic processor cell of claim 1, wherein the eight optical inputs comprise eight silicon-nitride waveguides on a silicon-on-insulator substrate.

10. The integrated photonic processor cell of claim 1, further comprising phase-shifter elements associated with respective ones of the eight optical inputs and a calibration controller configured to adjust the phase-shifter elements based on balance output detected at the balance output structure under a known neutral input pattern.

11. The integrated photonic processor cell of claim 1, wherein the detector comprises a balanced photodetector arrangement optically coupled to the balance output structure.

12. The integrated photonic processor cell of claim 1, further comprising threshold logic configured to compare a detector output from the detector with the threshold condition and assert the electrical imbalance signal when the threshold condition is satisfied.

13. The integrated photonic processor cell of claim 1, wherein the electrical imbalance signal is configured for use by computation-control circuitry to cause at least one computation-control response selected from invalidation, stall, gating, output suppression, rewind, rollback, re-execution, checkpoint restoration, selective replay, recalibration request, interrupt generation, and exception handling.

14. The integrated photonic processor cell of claim 1, wherein the detector is configured to generate the electrical imbalance signal with a detection latency of less than 5 ns.

15. The integrated photonic processor cell of claim 1, wherein calibrated neutral operation produces balance-output extinction of at least 25 dB at the balance output structure.

16. A method of optical-domain balance enforcement, comprising receiving, at eight optical inputs of an integrated photonic processor cell, an eight-channel optical word; interferometrically processing the eight-channel optical word to isolate a DC or summed balance witness component from non-balance optical content; routing the DC or summed balance witness component to a balance output structure; routing the non-balance optical content to one or more compute outputs; optically detecting residual optical output at the balance output structure; and generating an electrical imbalance signal when the residual optical output satisfies a threshold condition.

17. The method of claim 16, wherein interferometrically processing the eight-channel optical word comprises generating, at the balance output structure, an amplitude corresponding to a scaled sum of eight channel amplitudes of the eight-channel optical word.

18. The method of claim 16, further comprising using the electrical imbalance signal to control computation by performing at least one of invalidating a result, stalling a pipeline, suppressing a writeback, rewinding to a prior state, rolling back an operation, re-executing an operation, restoring a checkpoint, selectively replaying an operation, requesting recalibration, generating an interrupt, or generating an exception.

19. A photonic processing system comprising a plurality of integrated photonic processor cells, each integrated photonic processor cell comprising eight optical inputs, an interferometric network configured to isolate a DC or summed balance witness component of an eight-channel optical word from non-balance optical content, a balance output structure configured to carry the DC or summed balance witness component, one or more compute outputs configured to carry the non-balance optical content, and a detector configured to generate an electrical imbalance signal in response to residual optical output at the balance output structure satisfying a threshold condition; and control logic coupled to receive one or more electrical imbalance signals from the plurality of integrated photonic processor cells and configured to control computation based on the one or more electrical imbalance signals.

20. The photonic processing system of claim 19, wherein the plurality of integrated photonic processor cells comprises an array of at least 16 integrated photonic processor cells, and wherein the control logic is configured to prevent commitment of a result, suppress a writeback, initiate rollback, request replay, request recalibration, or generate an exception in response to at least one of the one or more electrical imbalance signals.
